(19) United States
(12) Patent Application Publication
(10) Pub. No.: US 2024/0120717 A1
(43) Pub. Date: Apr. 11, 2024

(54) HIGH PRECISION CABLE STRIPPING TOOLS

(71) Applicant: Hubbell Power Systems, Inc., Shelton, CT (US)

(72) Inventors: Will Eisele, Rocky Hill, CT (US); Brian Bourgoin, Cromwell, CT (US)

(73) Assignee: Hubbell Power Systems, Inc., Shelton, CT (US)

(21) Appl. No.: 18/484,336

(22) Filed: Oct. 10, 2023

Related U.S. Application Data
(60) Provisional application No. 63/378,733, filed on Oct. 7, 2022.

(51) Int. Cl. H02G 1/12

(52) U.S. Cl. CPC H02G 1/1212

(57) ABSTRACT

A tool for stripping a cable is provided that includes a first housing section having a first blade, a second housing section having a second blade, and a first beam secured to the housing sections. The housing sections are movable between a load/unload position and a strip position. The blades, when in the load/unload position, are spaced from one another by a distance that is larger than an outer diameter of the cable. The blades, when in the strip position, are spaced from one another by a first dimension (D₁) that is substantially equal to an outer diameter of a conductor of the cable. The first beam is positioned with respect to the blades to define a travel limiter to the cable such that an end of the cable in contact with a surface of the first beam is a predefined first length (L1) from the first and second blades.

### CROSS REFERENCE TO RELATED APPLICATIONS

This application claims benefit of U.S. Application 63/378,733 filed Oct. 7, 2022, the entire contents of which are incorporated herein by reference.

### BACKGROUND

### 1. Field of the Invention

The present disclosure relates to cable stripping tools. More particularly, the present disclosure relates to high precision cable stripping tools.

### 2. Description of Related Art

Many communication and/or optical cables having a circular cross section are constructed of multiple layers. Some cables require the multiple layers to be stripped at different lengths along the cable. Further, the layers can have different thicknesses and materials.

The depth of cut tolerances during the stripping process can be critical, and can require cutting through several different layers while simultaneously stopping at a specific depth. Thus, the stripping process can require cutting of some layers, while ensuring no contact is made with other layers to prevent scratching or marring of some layers. The tolerances—in terms of cleanliness of the cut layer edges during the stripping process can also be critical.

Failure to meet the required tolerances or other improper stripping attributes can result in the cables having improperly installed connectors. Improperly installed connectors can lead to premature failure of the cable and/or connector—as well as degraded or spotty communications.

Unfortunately, these issues can increase the time necessary to properly repeat the stripping and connector installation process, which in large installation projects can drive up cost and time to completion and require testing to find and rework to correct failed connections.

Accordingly, it has been found that there is a continuing need for improved cable stripping tools that overcome, alleviate, and/or mitigate one or more of the aforementioned and other deleterious effects of prior art tools.

### SUMMARY

A tool for stripping a cable is provided. The tool includes a first housing section having a first blade, a second housing section having a second blade, a first beam secured to the first and second housing sections. The first and second housing sections are linearly movable with respect to one another between a load/unload position and a strip position. The first and second blades, when in the load/unload position, are spaced from one another by a distance that is larger than an outer diameter of the cable. The first and second blades, when in the strip position, are spaced from one another by a first dimension (D₁) that is substantially equal to an outer diameter of a conductor of the cable. The first beam is positioned with respect to the first and second blades to define a travel limiter to the cable such that an end of the cable in contact with a surface of the first beam is a predefined first length (L1) from the first and second blades.

In some embodiments either alone or together with any one or more of the aforementioned and/or after-mentioned embodiments, the first and second housing sections each have a shoulder. The first and second blades have a cutting edge in contact with the shoulder, respectively, to ensure that the cutting edges are spaced by the first dimension (D₁).

In some embodiments either alone or together with any one or more of the aforementioned and/or after-mentioned embodiments, the first and second housing sections each have a first shelf on which the first and second blades are secured by one or more threaded fasteners, respectively.

In some embodiments either alone or together with any one or more of the aforementioned and/or after-mentioned embodiments, the first and second housing sections each have a tapered ramp opposite the shoulder, respectively. The tapered ramp being inclined towards the shoulder such that, upon tightening of the threaded fastener, the first and second blades are biased against the shoulder, respectively.

In some embodiments either alone or together with any one or more of the aforementioned and/or after-mentioned embodiments, the first housing section has a third blade and the second housing section has a fourth blade. The third and fourth blades, when in the load/unload position, are spaced from one another by a distance that is larger than the outer diameter of the cable. The third and fourth blades, when in the strip position, are spaced from one another by a second dimension (D₂) that is substantially equal to an outer diameter of a shield layer of the cable.

In some embodiments either alone or together with any one or more of the aforementioned and/or after-mentioned embodiments, the first beam is positioned a predefined second length (L2) from the third and fourth blades.

In some embodiments either alone or together with any one or more of the aforementioned and/or after-mentioned embodiments, the first and second housing sections further include a second beam. The first and second blades being on one side of the second beam and the third and forth blades being on an opposite side of the second beam so that the second beam defines a predefined third length (L3) therebetween.

In some embodiments either alone or together with any one or more of the aforementioned and/or after-mentioned embodiments, further including a guide shaft and a biasing member. The first and second housing sections being slidably engaged with the guide shaft for movement between the load/unload position and the strip position. The biasing member normally biasing the first and second housing sections to the load/unload position or to the strip position.

In some embodiments either alone or together with any one or more of the aforementioned and/or after-mentioned embodiments, the first housing section and the second housing section each have a primary handle and a blade subassembly. The blade subassemblies carrying the first and second blades.

A tool for stripping a cable is also provided that has a first housing section and a second housing section each with a primary handle, a blade subassembly, a shoulder, a first beam, and a biasing member. The primary handle of the first housing section is operatively connected to the blade subassembly of the first housing section. The primary handle of the second housing section is operatively connected to the blade subassembly of the second housing section. The blade subassemblies moving with respect to one another between a load/unload position and strip position. The blade subassemblies each have a first blade and a second blade. The first beam being positioned with respect to the first blades to define a travel limiter to the cable such that an end of the cable in contact with the first beam is a first length (L1) along a cable axis (C_{A}) from the first blades and is a second length (L₂) along the cable axis (C_{A}) from the second blades. The blade subassemblies each have a second beam that separate the first and second blades from one another by a third length (L3) along the cable axis (C_{A}). The shoulder defines a second datum that sets the cutting edge of the first blades distanced from one another by a first dimension (D₁) that is substantially equal to an outer diameter of a conductor of the cable and the cutting edge of the second blades distanced from one another by a second dimension (D₂) that is substantially equal to an outer diameter of a shield layer of the cable. The first and second blades, when in the load/unload position, are spaced from one another by a distance that is larger than an outer diameter of the cable. The first and second blades, when in the strip position, are spaced from one another by a distance that is substantially equal to the first and second dimensions (D₁, D₂).

In some embodiments either alone or together with any one or more of the aforementioned and/or after-mentioned embodiments, the biasing members normally bias the first and second housing sections to the strip position.

In some embodiments either alone or together with any one or more of the aforementioned and/or after-mentioned embodiments, the shoulder is secured to an upper surface of the second beam.

In some embodiments either alone or together with any one or more of the aforementioned and/or after-mentioned embodiments, the shoulder is integrally formed as one piece with the second beam.

In some embodiments either alone or together with any one or more of the aforementioned and/or after-mentioned embodiments, the first and second housing sections each further include an inlet guide.

In some embodiments either alone or together with any one or more of the aforementioned and/or after-mentioned embodiments, the inlet guide includes a first nozzle to guide the cable and the blade subassembly has a second nozzle to guide the cable. The second nozzle being on the second beam.

In some embodiments either alone or together with any one or more of the aforementioned and/or after-mentioned embodiments, the first beams and the inlet guides, when in the strip position, enclose portions stripped from the cable.

In some embodiments either alone or together with any one or more of the aforementioned and/or after-mentioned embodiments, the first and second housing sections each further include an ejection pin. The ejection pins withdrawn into the blade subassemblies in the strip position and extending from the blade subassemblies in the load/unload position.

A method of stripping a cable is provided that includes: inserting the cable into a stripping tool when first and second housing sections of the stripping tool are in a load/unload position until an end of the cable contacts an upper surface of a first beam; moving the first and second housing sections of the stripping tool to a strip position; rotating the stripping tool and the cable at least 180-degrees about a cable axis (C_{A}) with respect to one another while the housing sections are in the stripping position; and moving the stripping tool and the cable with respect to one another along the cable axis (C_{A}) while the first and second housing sections are in the stripping position to strip portions from the cable.

In some embodiments either alone or together with any one or more of the aforementioned and/or after-mentioned embodiments, the method includes applying pressure, prior to inserting the cable, to the first and second housing sections to overcome a biasing member to move the first and second housing sections from the stripping position to the load/unload position. The step of moving the first and second housing sections to the stripping position includes releasing the pressure so that the biasing member returns the first and second housing sections to the stripping position.

In some embodiments either alone or together with any one or more of the aforementioned and/or after-mentioned embodiments, the method includes applying pressure, after the portions have been stripped from the cable, to the first and second housing sections to overcome the biasing member to move the first and second housing sections from the stripping position to the load/unload position so as to eject the portions from the stripping tool.

The above-described and other features and advantages of the present disclosure will be appreciated and understood by those skilled in the art from the following detailed description, drawings, and appended claims.

### BRIEF DESCRIPTION OF THE DRAWINGS

FIG. 1 is a top perspective view of an exemplary embodiment of a cable stripping tool according to the present disclosure shown in a first or loading position;

FIG. 2 is a top perspective view of the tool of FIG. 1 shown in a second or stripping position;

FIG. 3 is a top perspective view of the tool of FIG. 1 having certain portions shown as transparent;

FIG. 4 is a bottom perspective view of the tool of FIG. 1;

FIG. 5 is a side perspective view of a coaxial cable having a number of layers;

FIG. 6 is a side perspective view of a coaxial cable after being stripped by the tool of FIG. 1;

FIG. 7 is a sectional view of the tool of FIG. 2;

FIG. 8 is an enlarged view of the tool taken at circle 7 in FIG. 7;

FIG. 9 is a top view of the tool of FIG. 2;

FIG. 10 is an enlarged view of the tool taken at circle 9 in FIG. 9;

FIG. 11 is an enlarged top perspective view of the tool of FIG. 2;

FIG. 12 is an enlarged bottom, partial perspective view of the tool of FIG. 2;

FIG. 13 is a front perspective view of another exemplary embodiment of a cable stripping tool according to the present disclosure shown in a first or loading position;

FIG. 14 is a rear perspective view of the tool of FIG. 13 in the first or loading position;

FIG. 15 is a front perspective view of the tool of FIG. 13 in a second or stripping position;

FIG. 16 is a rear perspective view of the tool of FIG. 13 in the second or stripping position;

FIG. 17 is a perspective view of various components of the tool of FIG. 13;

FIG. 18 is a perspective view of a blade subassembly of the tool of FIG. 13 in a disassembled state;

FIG. 19 is a perspective view of the blade subassembly in relation to a first beam, which set the distance of the cutting blades with respect to one another in a direction along a length of the cable;

FIG. 20 is a side view of FIG. 19;

FIG. 21 is a side view of datum setting shoulder, which sets the height of the cutting blades with respect to one another in a direction perpendicular to the cable.

FIG. 22 is a side view of FIG. 21;

FIG. 23 is an enlarged partial perspective view of the tool of FIG. 13 in the first or loading position illustrating an ejection pin in an ejection position; and

FIG. 24 is an enlarged partial perspective view of the tool of FIG. 13 during movement between the first and second positions illustrating the ejection pin withdrawn.

### DETAILED DESCRIPTION

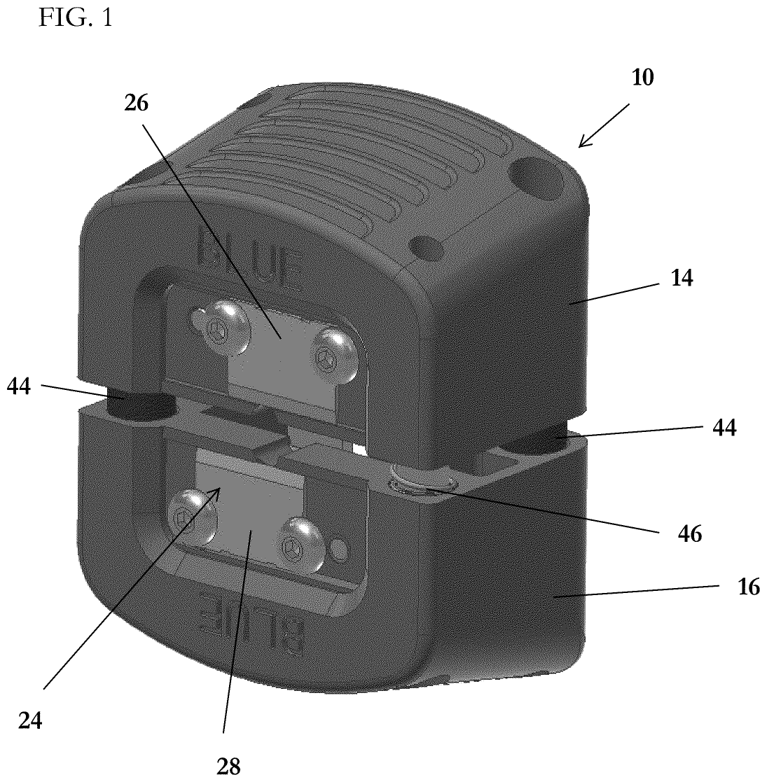

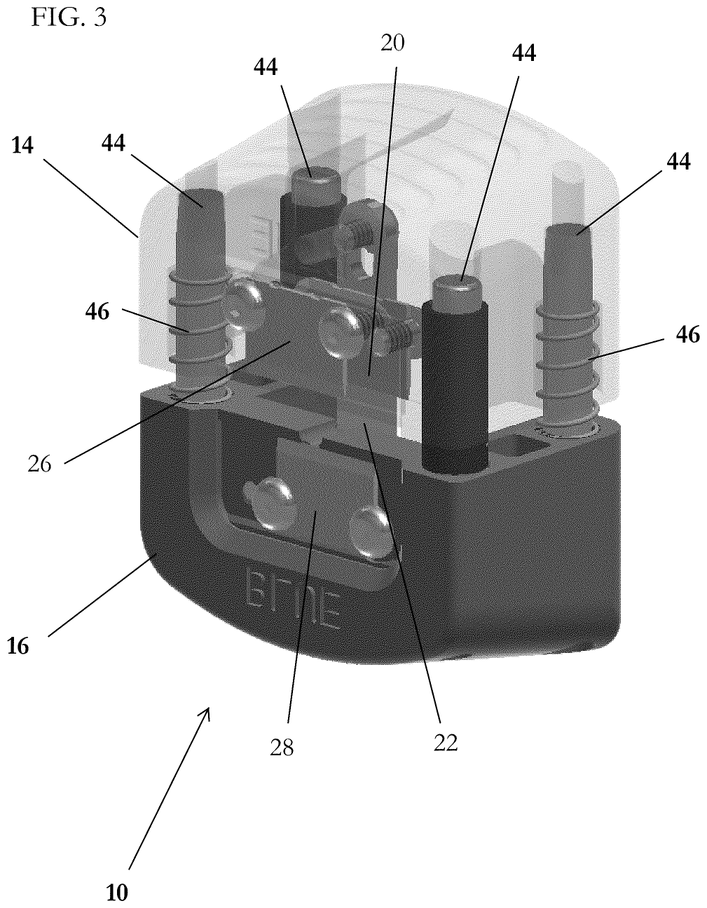

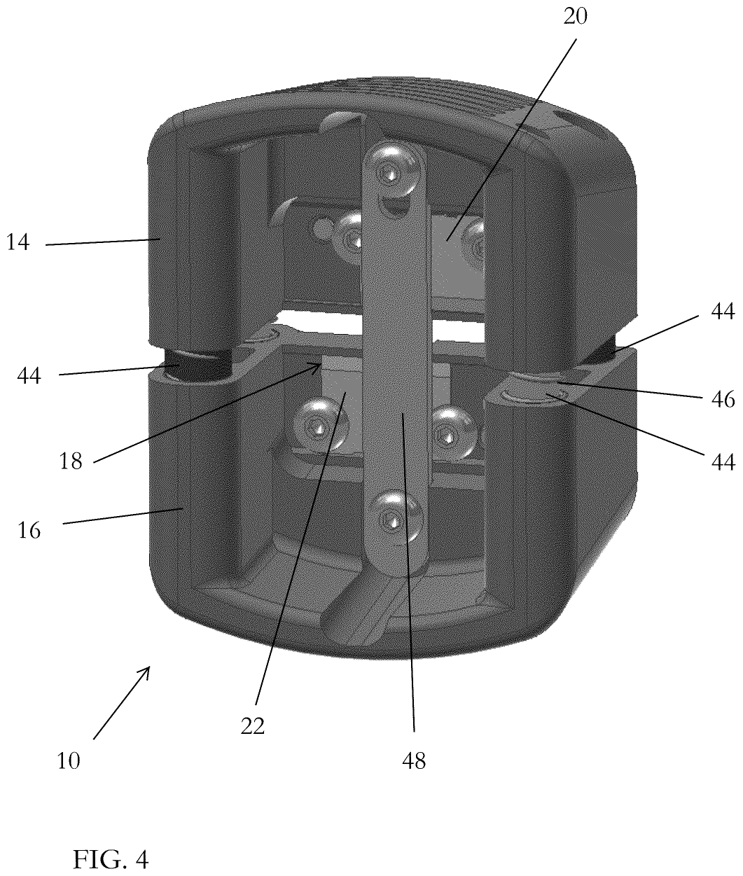

Referring to the figures and in particular to FIGS. 1-4, an exemplary embodiment of a cable stripping tool is shown and is generally referred to by reference numeral 10. Tool 10 is advantageously configured to strip cables having very thin outer jacket layers that require high precision strips—and, in some embodiments, cables having multiple layers that require multiple, high precision strips.

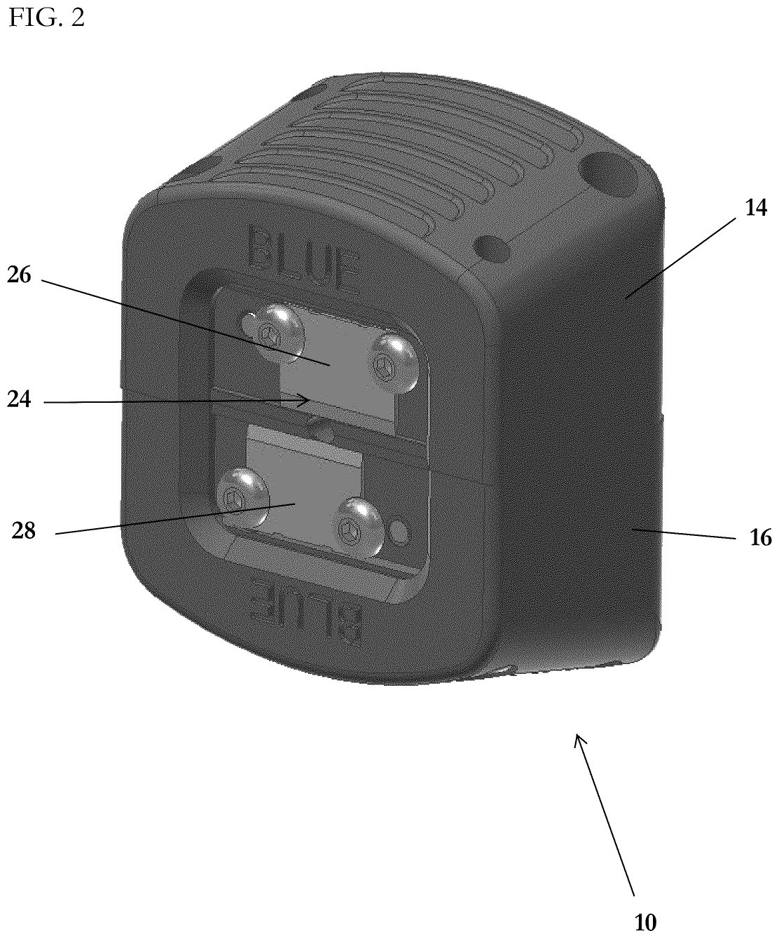

Tool 10 has a first housing section 14 and a second housing section 16, which are movable with respect to one another between first or load position (FIGS. 1 and 3-4) and second or strip position (FIG. 2).

Tool 10 has a first blade set 18 with opposing blades 20, 22, where blade 20 is positioned on section 14 and blade 22 is positioned on section 16. In some embodiments and as illustrated, tool 10 can include a second blade set 24 of opposing blades 26, 28, where blade 26 is positioned on section 14 and blade 28 is positioned on section 16. In this manner, tool 10 is configured to form a first stripping position at first blade set 18 and, when present, a second stripping position at second blade set 20.

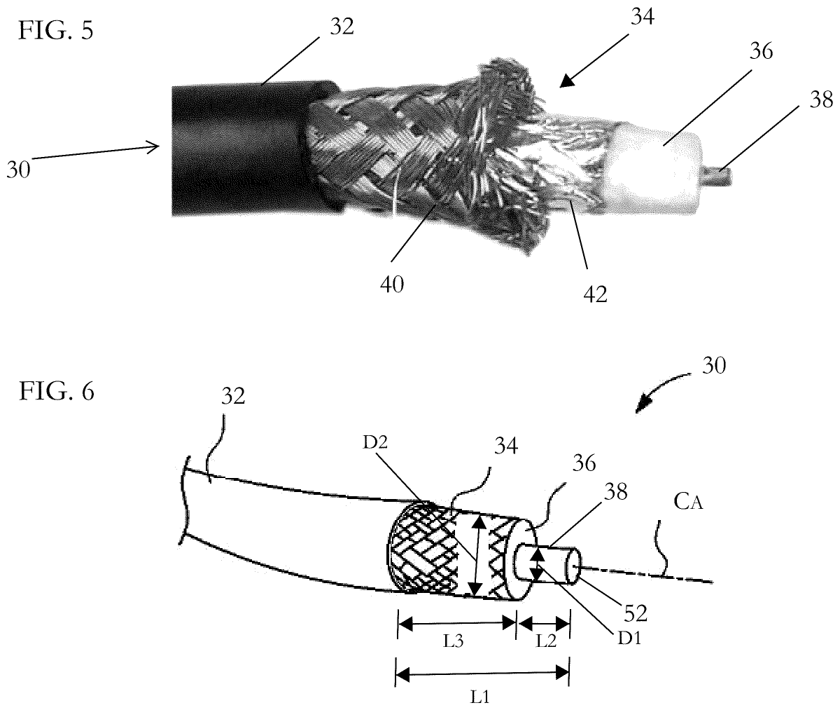

Tool 10 is configured for use with communication and/or optical cables (“cable”) having a circular cross section and constructed of multiple layers. The construction of an exemplary cable that finds use with tool 10 is shown in FIG. 5 and is generally referred to by reference numeral 30.

Cable 30 is shown by way of example as a coaxial cable that has an outer or jacket layer 32, a shield layer 34, a dielectric layer 36, and a center conductor 38. Jacket layer 32 is a protective layer, while shield layer 34 mitigates passage of electromagnetic interference to center conductor 38. Dielectric layer 36 mechanically and electrically separates shield layer 34 and center conductor 38. In some examples, shield layer 34 can be made of a braided layer 40 and/or a foil layer 42.

It should be recognized that cable 30 is described by way of example only as a coaxial cable. However, tool 10 is configured for use for cables having very thin jacket layers that require high precision. These cables can include single axis cable, coaxial cables, triaxial cables, and others.

Cable 30 can be stripped in a manner required to operatively couple with a desired connector (not shown) configuration. For example and as shown in FIG. 6, cable 30 can be stripped so shield layer 34 is exposed a first length (L₁) along a cable axis (C_{A}) and conductor 38 is exposed a second length (L₂) along the cable axis (C_{A}).

Stated differently, cable 30 has both a first strip where only jacket layer 32 has been removed across a longer, first length (L₁) to expose shield layer 34 and a second strip, where jacket layer 32, shield layer 34, and dielectric layer 36 have been removed across a shorter second length (L₂) to expose conductor 38.

The various layers 32, 34, 36 of cable 30 have different thicknesses defined along a cable radius (C_{R}). Thus, the stripping of cable 30 to the state shown in FIG. 6 where there are both the first and second strips, involves cutting the layers of cable 30 to different depths along cable axis (C_{A}) and to different lengths along the cable axis. Advantageously, tool 10 is configured, in some embodiments, to simultaneously provide the first and second strips to cable 30.

Referring again to FIGS. 1-4, tool 10 is shown having first and second housing sections 14, 16 that are symmetrical to one another. Of course, it is contemplated by the present disclosure for tool 10 have housing sections 14, 16 that are non-symmetrical with respect to one another.

Tool 10 is configured for linear movement of first and second housing sections 14, 16 with respect to one another. As used herein, the term linear movement means that housing sections 14, 16 move with respect to one another such that blades 20, 22 of first blade set 18 move with respect to one another within the same plane—and such that, when present, blades 26, 28 of second blade set 24 move with respect to one another within the same plane.

In some embodiments, first and second housing sections 14, 16 are secured to one another by guide shafts 44 where at least one of the housing sections is slidably engaged with the guide shafts. In the illustrated embodiment, tool 10 is shown having four guide shafts 44. Of course, it is contemplated by the present disclosure for tool 10 have any desired number of guide shafts 44 sufficient to provide the desired movement between sections 14, 16.

In some embodiments, tool 10 can include a biasing member 46 configured to normally bias housing sections 14, 16 to a desired position with respect to one another. In the illustrated embodiment, biasing member 46 is shown as a compression spring positioned around guide shaft 44 so as to normal biases housing sections 14, 16 to the first or loading position.

However, it is contemplated by the present disclosure for biasing member 46 to be any member configured to normally bias housing sections 14, 16 to a desired position—where that desired position can be the first or loading position, the second or stripping position, or any position therebetween. For example, it is contemplated by the present disclosure for biasing member 46 to be a spring such as, but not limited to a compression spring, tension spring, torsion spring, leaf spring, and others. It is further contemplated by the present disclosure for biasing member 46 to be integrally formed or molded into housing sections 14, 16 or to be separate components from the housing sections.

Tool 10 includes a first beam 48. Beam 48 defines an outermost open position of housing sections 14, 16 and prevents the sections from separating from one another. Beam 48 is secured to housing sections 14, 16 so as to allow for movement of the sections with respect to one another. In the illustrated embodiment, beam 48 includes an elongated opening that permits housing section 14 to move or slide with respect to beam 48. Of course, it is contemplated by the present disclosure for beam 48 to have any structure sufficient to allow for movement of housing sections 14, 16.

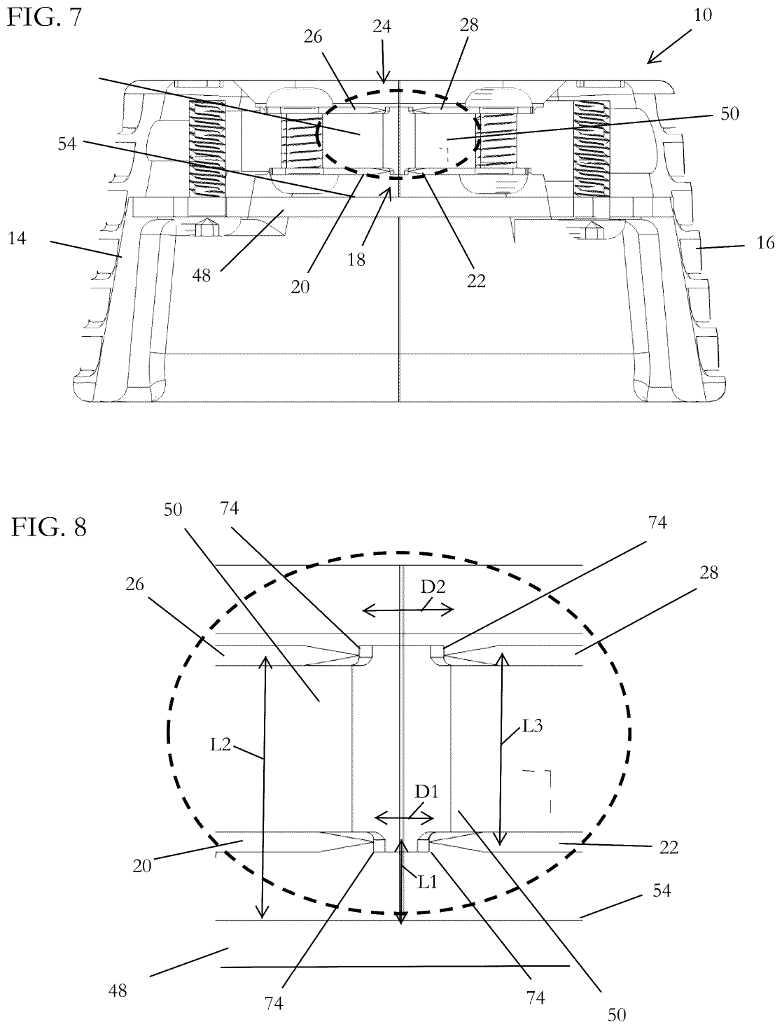

In some embodiments, first beam 48 can function as a travel limiter or stop when inserting cable 30 into tool 10 as described in more detail with reference to FIGS. 7-10. Tool 10, when having second blade set 24, can further include a second beam 50 configured so that the second blade set is offset from first blade set 18 by a distance equal to a third length (L₃).

Advantageously and in this manner, beams 48, 50 cooperate to allow tool 10 to be easily and repeatably used to strip cable 30 to the configuration shown in FIG. 6.

Cable 30 can be inserted into tool 10 until an end 52 of the cable contacts a top surface 54 of beam 48. For example, when tool 10 is in the first or load position, blades 20, 22 of first blade set 18 and, when present, blades 26, 28 of second blade set 24, have cutting edges that are spaced from one another by a distance that is larger than an outer diameter of cable 30 (i.e., outer diameter of jacket layer 32). In this position, cable 30 can be inserted into tool 10 without interference or damage by blade sets 18, 24.

Tool 10, in the second or strip position, is configured so that blades 20, 22 of first blade set 18 have cutting edges spaced from one another by a distance that is substantially equal to the outer diameter of conductor 38—namely of cable 30 without jacket layer 32, shield layer 34, or dielectric layer 36.

Furthermore, tool 10, in the second or strip position, is configured so that blades 26, 28 of second blade set 24, when present, have cutting edges spaced from one another by a distance that is substantially equal to the outer diameter of shield layer 34. Stated differently, the distance between blades 26, 28 in the second or stripped position is shown as second dimension (D₂).

As used herein, the term “substantially equal” shall mean tolerances that allow for the stripping of the desired layers without damage to remaining layers.

In one example, cable 30 has an overall outer diameter of 0.125″ with a thickness of jacket layer 32 of 0.008″ and a diameter of conductor 38 of 0.05″. These dimensions of cable 30 may vary due to, for example, tolerances inherent in the manufacturing of the cable. In this example, tool 10 is configured so that first dimension (D₁) of blade set 18 is set to strip jacket layer 32, namely is set to 0.0117″ with a tolerance of about +/−0.002″ with about +/−0.001″ being preferred. Here, tool 10 is also configured so that second dimension (D₂) of blade set 26 is set to strip jacket layer 32, shield layer 34, and dielectric layer 36, namely is set to 0.05″ with a tolerance of about +/−0.002″ with about +/−0.001″ being preferred.

In another example, cable 30 has an overall outer diameter of 0.375″ with a thickness of jacket layer 32 of 0.015″ and a diameter of conductor 38 of 0.125″. These dimensions of cable 30 may vary due to, for example, tolerances inherent in the manufacturing of the cable. In this example, tool 10 is configured so that first dimension (D₁) of blade set 18 is set to strip jacket layer 32, namely is set to 0.360″ with a tolerance of about +/−0.002″ with about +/−0.001″ being preferred. Here, tool 10 is also configured so that second dimension (D₂) of blade set 26 is set to strip jacket layer 32, shield layer 34, and dielectric layer 36, namely is set to 0.125″ with a tolerance of about +/−0.002″ with about +/−0.001″ being preferred.

Tool 10 is configured, by positioning of beams 48, 50, so that top surface 54 is positioned from the edge of cutting blades 20, 22 of first blade set 18 by distance equal to first length (L₁) and so that top surface 54 is positioned from the edge of cutting blades 26, 28 of second blade set 24 by distance equal to second length (L₂).

In the second or strip position, tool 10 can be rotated about cable axis (C_{A}) to just over 180-degrees to complete the severing of layers 32, 34, 36 to be stripped from cable 30. Once severed, tool 10 can be moved along cable axis (C_{A}) to remove the severed layers.

In this manner, tool 10 is configured to ensure that the layers of cable 30 can be stripped as shown in FIG. 6—namely with jacket, shield, and dielectric layers 32, 34, 36 stripped by first length (L₁) and with jacket layer 32 stripped by second length (L₂).

Advantageously, tool 10 is configured, in some embodiments, to simultaneously provide the first and second strips to cable 30. The use of tool 10 includes the basic, easily repeatable steps of: inserting cable 30 into tool 10 when housing sections 14, 16 of the tool are in the first or load position (FIG. 1) until end 52 of the cable contacts upper surface 54 of first beam 48, moving the housing sections to the second or stripping position (FIG. 2), rotating tool 10 and cable 30 at least 180-degrees with respect to one another while the housing sections are in the second or stripping position, and moving tool 10 and cable 30 with respect to one another along the cable axis (C_{A}) while the housing sections are in the second or stripping position.

Thus, tool 10 creates symmetrical and even cuts through specific layers of cable 30 and at specific locations in a precise and repeatable manner. In short, tool 10 provides a two cuts of the layers of cable in a single stripping process.

In some embodiments, tool 10 is configured to ensure blades 20, 22 and, when present blades 26, 28, remain in a desired position with respect to one another—namely first blade set 18 with edges spaced by first dimension (D₁) and second blade set 24 with edges spaced from one by second dimension (D₂).

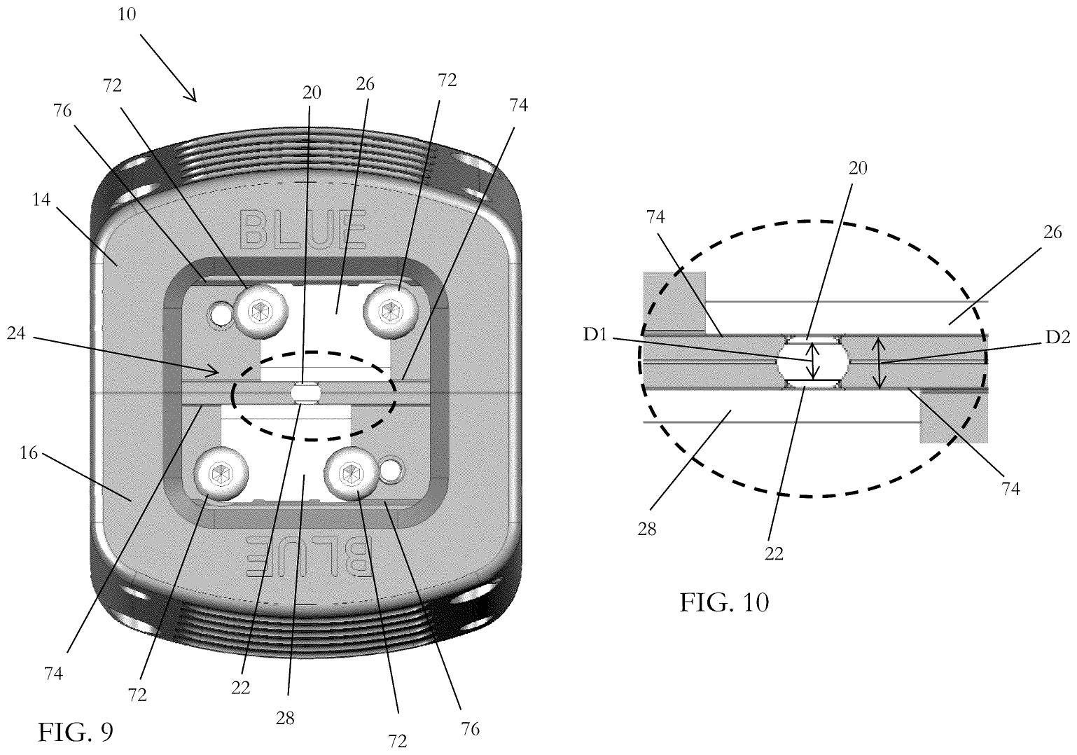

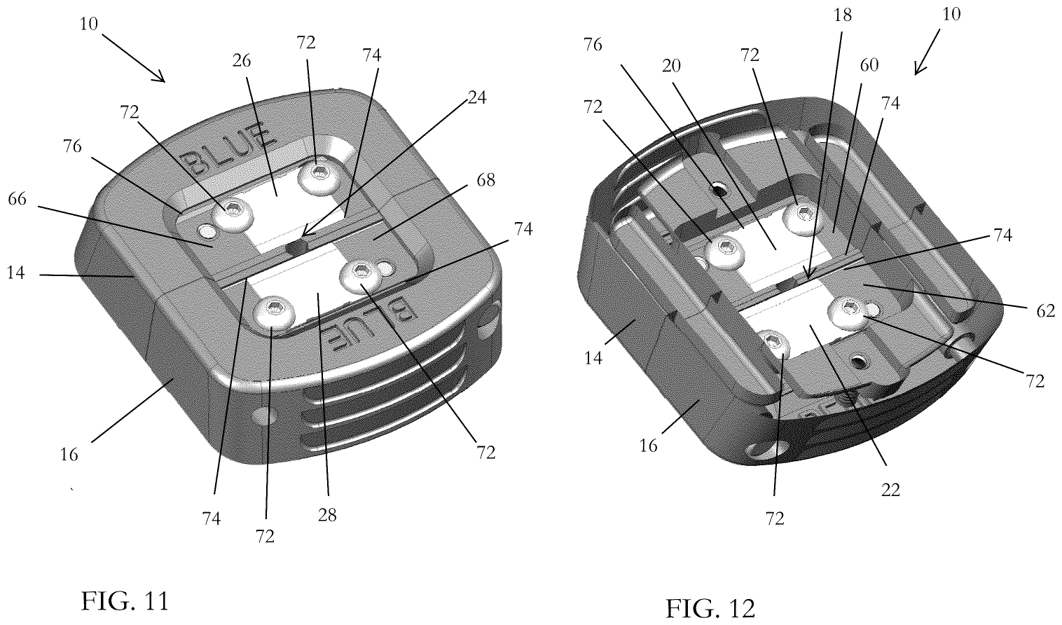

Referring now to FIGS. 9-12, tool 10 include a first shelf 60, 62 on housing sections 14, 16 on which blades 20, 22 are secured, respectively. Further and when second blade set 24 is present, tool 10 include a second shelf 66, 68 on housing sections 14, 16 on which blades 26, 28 are secured, respectively.

Shelves 60, 62, 66, 68 can include one or more features configured to ensure the positioning of the blades. For example, shelves 60, 62, 66, 68 can include one or more threaded fasteners 72 to secure blades 20, 22, 26, 28 in a desired position.

Shelves 60, 62, 66, 68 can include a shoulder 74 positioned at the cutting edge of blades 20, 22, 26, 28 in a desired position. Shoulder 74 defines a datum that sets the cutting edge of the blades distanced from one another by first and second dimensions (D₁, D₂), respectively.

In still other embodiments, shelves 60, 62, 66, 68 can include a tapered ramp 76 opposite shoulder 74. Tapered ramp 76 is inclined towards shoulder 74 such that, upon tightening of threaded fasteners 72, blades 20, 22, 26, 28 are biased towards and, preferably, against shoulder 74.

When in position against shoulder 74, blades 20, 22, 26, 28 are accurately positioned with respect to one another such that tool 10, when housing sections 14, 16 are in the second or stripping position, the cutting edges of blade set 18 are spaced from one another by first dimension (D₁) and the cutting edges of blade set 26 are spaced from one another by second dimension (D₂). In this manner, tool 10 provides a level of accuracy due to less tolerance stack-up than previously possible.

In some embodiments, tool 10 is configured so that housing sections 14, 16 are enclosed to maintain layers of cable 30 severed during the stripping process within the tool. For example, tool 10 can include a cover (not shown) on housing sections 14, 16 at a side opposite blades 26, 28. In another example, tool 10 can include overlapping portions on housing sections 14, 16 such that one section moves within the other section when during movement from the first or loading position to the second or stripping position.

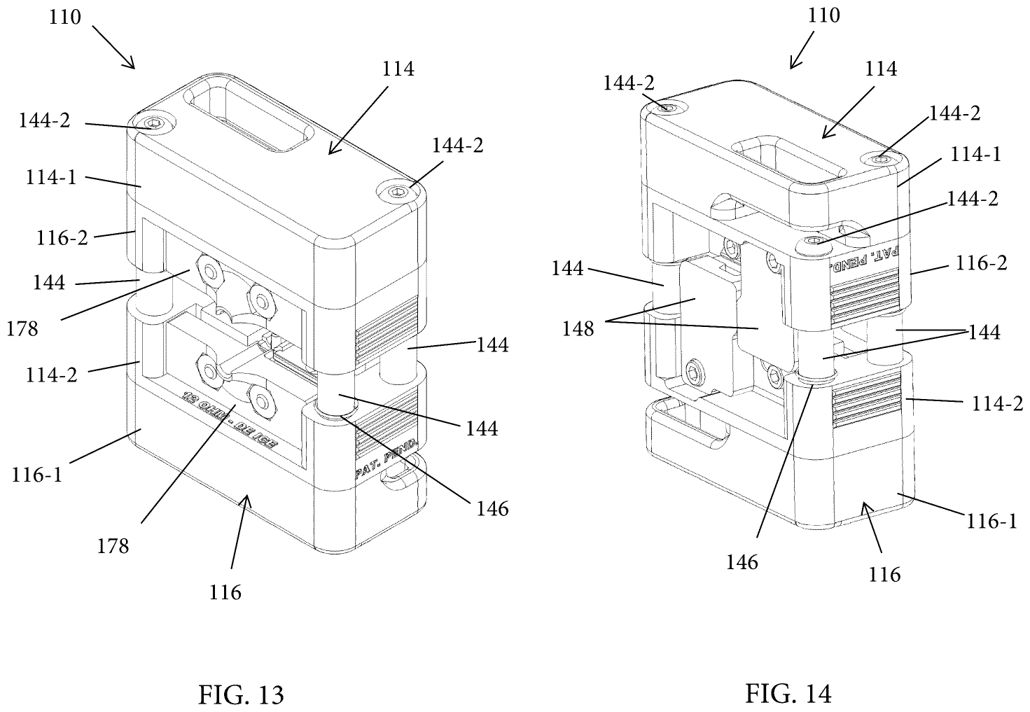

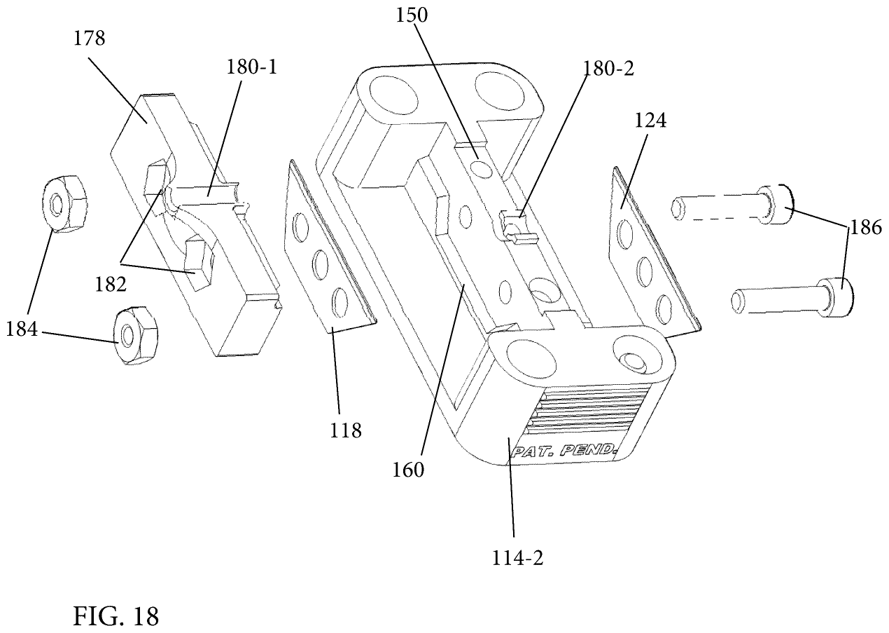

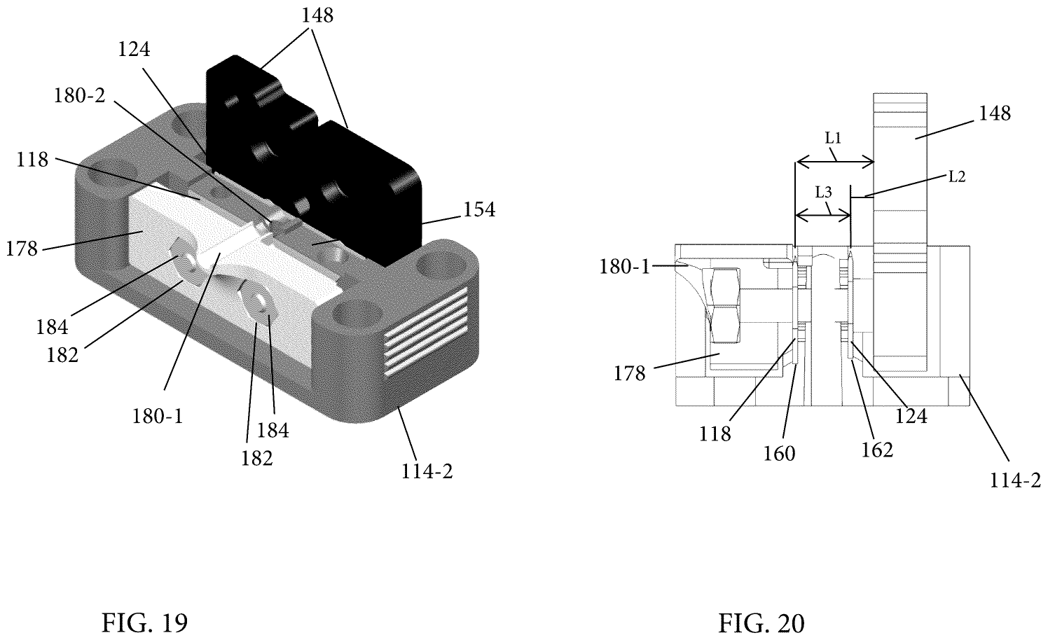

Referring to the figures and in particular with simultaneous reference to FIGS. 13-24, an alternate exemplary embodiment of a cable stripping tool is shown and is generally referred to by reference numeral 110 where component parts performing similar or analogous functions are labeled in multiples of one hundred as to tool 10.

Tool 110, like tool 10, is advantageously configured to strip cables 30 (FIG. 6) having very thin outer jacket layers that require high precision strips—and, in some embodiments, cables having multiple layers that require multiple, high precision strips.

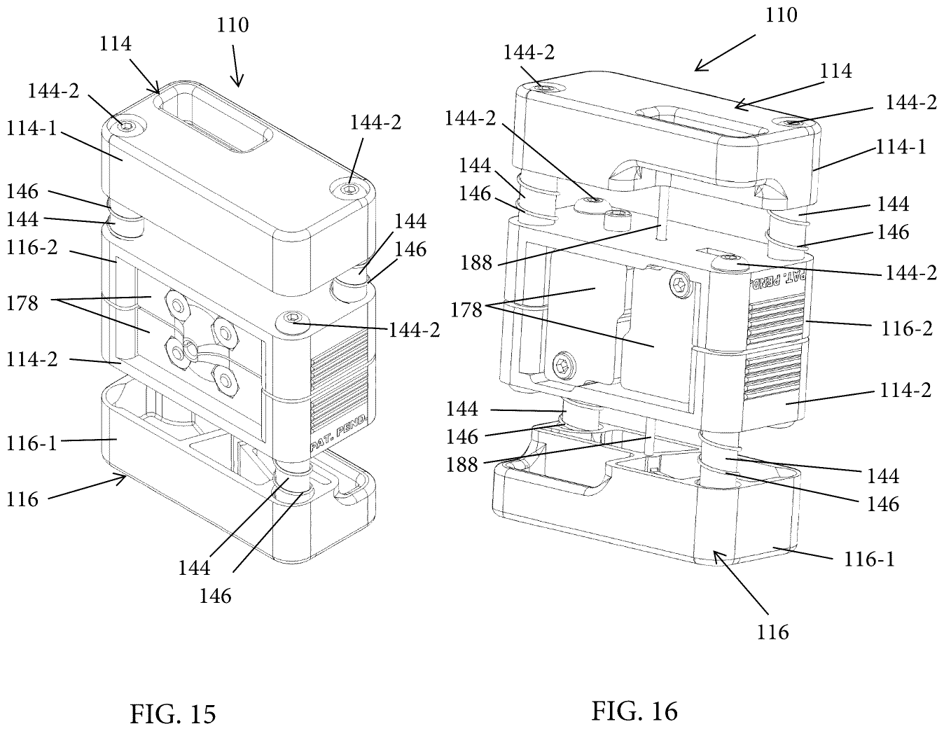

Tool 110 has a first housing section 114 and a second housing section 116, which are linearly movable with respect to one another between a first or load/unload position (FIGS. 13-14) and second or strip position (FIGS. 15-16).

First housing section 114 includes a primary handle 114-1 operatively connected to a blade subassembly 114-2 by one or more guide shafts 144 (two shown). Similarly, second housing section 116 includes a primary handle 116-1 operatively connected to a blade subassembly 116-2 by one or more guide shafts 144 (two shown).

In the illustrated embodiment, tool 110 is shown having four guide shafts 144. Of course, it is contemplated by the present disclosure for tool 110 have any desired number of guide shafts 144 sufficient to provide the desired movement between sections 114, 116.

Guide shafts 144 are shown as having threaded ends 144-1 that threadably engage fasteners 144-2. In this manner, guide shafts 144 both ensure linear movement of blade subassemblies 114-2, 116-2 and connect the guide shafts to primary handles 114-1, 116-1 and to the blade subassemblies.

In some embodiments, tool 110 can include a biasing member 146 configured to normally bias first and second housing sections 114, 116 to a desired position with respect to one another. In the illustrated embodiment, biasing member 146 is shown as a compression spring positioned around guide shaft 144 so as to normal bias housing sections 114, 116 to the second or strip position. Biasing members 146 positioned around guide shafts 144 between primary handle 114-1 and blade subassembly 116-2 bias first housing section 114 to the second or strip position, while the biasing members positioned around the guide shafts between primary handle 116-1 and blade subassembly 114-2 bias second housing section 116 to the second or strip position.

Without wishing to be bound by any particular theory, it is believed that tool 110 configured with first and second housing sections 114, 116 that are normally biased to the second or strip position is adapted to ensure a desired cutting force is applied to the cables. Stated differently, the biasing member(s) that normally bias first and second housing sections 114, 116 to the second or strip position ensure that the cutting blades are applied to the cables at a desired cutting force.

However, it is contemplated by the present disclosure for biasing member 146 to be any member configured to normally bias housing sections 114, 116 to a desired position—where that desired position can be the first or load/unload position, the second or stripping position, or any position therebetween. For example, it is contemplated by the present disclosure for biasing member 146 to be a spring such as, but not limited to a compression spring, tension spring, torsion spring, leaf spring, and others. It is further contemplated by the present disclosure for biasing member 146 to be integrally formed or molded into housing sections 114, 116 or to be separate components from the housing sections.

First and second housing sections 114, 116 each include a first beam 148. Additionally, blade subassemblies 114-2, 116-2 each have a first blade 118 respectively and a second blade 124 secured to one another with a second beam 150 positioned therebetween.

First beam 148 functions as a travel limiter or stop when inserting a cable (not shown) into tool 110. Here, first beams 148 establish a first datum that sets a position between the first beams and the edge of cutting blades 118, 124, respectively.

Sections 114, 116 are configured so that first beams 148 are positioned along the cable axis (C_{A}) from the cutting edges of blades 118 by distance equal to first length (L₁) and are positioned along the cable axis (C_{A}) from the cutting edges of blades 124 by a distance equal to second length (L₂).

Sections 114, 116 are configured so that second beams 150 offset the cutting edges of blades 118 along the cable axis (C_{A}) from the cutting edges of blades 124 by a distance equal to third length (L₃).

First and second blade subassemblies 114-2, 116-2 can each include a first shelf 160 at one side of second beams 150 on which first blades 118 are secured, respectively. Further, first and second blade subassemblies 114-2, 116-2 each include a second shelf 162 at an opposite side of second beams 150 on which second blades 124 are secured, respectively.

Tool 110, in the second or strip position, is configured so that blades 124 have cutting edges spaced from one another by a distance that is substantially equal to the outer diameter of conductor 38. Stated differently, the distance between blades 124 in the second or stripped position is shown as first dimension (D₁).

Further, tool 110, in the second or strip position, is configured so that blades 118 have cutting edges spaced from one another by a distance that is substantially equal to the outer diameter of shield layer 34. Stated differently, the distance between blades 118 in the second or stripped position is shown as second dimension (D₂).

As used herein, the term “substantially equal” shall mean tolerances that allow for the stripping of the desired layers without damage to remaining layers.

In some embodiments, first and second blade subassemblies 114-2, 116-2 can each include a shoulder 174 configured to accurately space the cutting edges of first blades 118, 124 to ensure the cutting of cables 30 to the first and second dimensions (D₁, D₂), respectively. In the illustrated embodiment, shoulders 174 are secured to an upper surface 154 of second beam 150, where the upper surface is perpendicular to the cutting edges of blades 118, 124. Without wishing to be bound by any particular theory, it is believed that separation of shoulders 174 from second beam 150 provide for increased dimensional precision with respect to setting the datum for first and second dimensions (D₁, D₂).

Of course, it is contemplated by the present disclosure for shoulders 174 to be, in some embodiments, integrally formed as one piece with first and second blade subassemblies 114-2, 116-2.

In some embodiments, first and second blade subassemblies 114-2, 116-2 can each include an inlet guide 178 having a first nozzle 180-1 that is configured to accurately position cable 30 in a desired location within tool 110 as tool 110 is returned to the second or strip position. Further, second beam 150 can, in some embodiments, further include a second nozzle 180-2 that cooperates with first nozzle 180-1 to accurately position cable 30 in a desired location within tool 110. Nozzles 180-1, 180-2 cooperate to position cable 30 at the portions of the cutting edges of blades 118, 124 that are exposed or uncovered by shoulder 174.

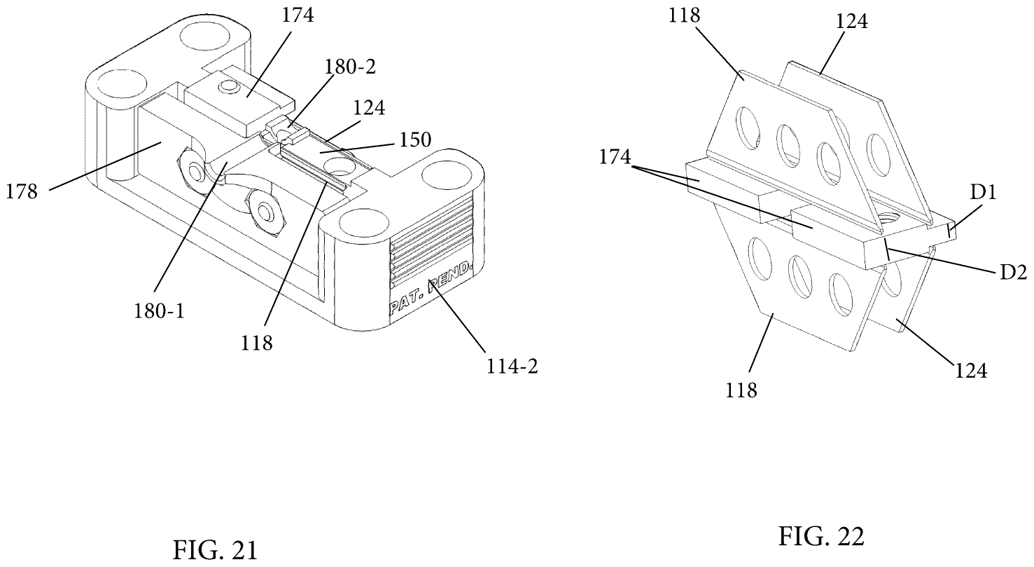

Inlet guide 178 can include recesses 182 that capture first fasteners 184 of blade subassemblies 114-2, 116-2. As shown in FIG. 21, blade subassemblies 114-2, 116-2 include second fasteners 186 passing through blade 124, second beam 150, blade 118, and inlet guide 178 then into operative engagement with first fasteners 184. Here, shoulder 174 is further shown secured to the upper surface 154 of beam 150.

In some embodiments, tool 110 is configured so that housing sections 114, 116 are enclosed to maintain layers of cable 30 severed during the stripping process within the tool. In the illustrated embodiment, tool 110, when in the second or stripping position, first beams 148 enclose one side of tool 110 and inlet guide 178 enclose the opposite side of the tool, which captures stripped portions of cable 30 within the tool until the tool is activated to the first or load/unload position (FIGS. 13-14).

Preferably, one side of tool 110 remains enclosed in the first or load/unload position to ensure that the stripped portions of cable 30 only exit the tool from one side. In the illustrated embodiment, first beams 148 not only enclose the rear side of tool 110 when in the first or load/unload position, but also function as the travel limiter or stop when inserting a cable (not shown) into the tool.

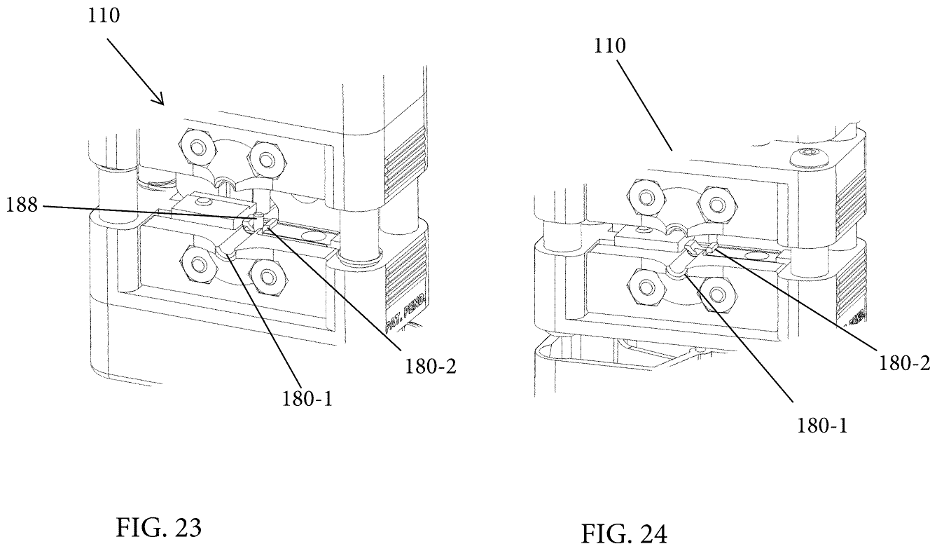

In some embodiments, first and second housing sections 114, 116 can include an ejection pin 188. Referring now to FIGS. 23-24, primary handles 114-1, 116-1 each have an ejection pin 188 secured thereto. Pins 188 slidably pass through an opening in blade subassemblies 114-2, 116-2, respectively, at a position where cable 30 is captured by nozzles 180-1, 180-2. When tool 110 is in the second or stripping position, pins 188 retract into blade subassemblies 114-2, 116-2. Conversely, when tool 110 is in the first or load/unload position, pins 188 extend from blade subassemblies 114-2, 116-2 to protrude into the nozzles 180-1, 180-2 and eject any portion of the stripped cable from the tool.

In use, the user applies pressure to primary handles 114-1, 116-1 sufficient to overcome the biasing force of members 146 and move blade subassemblies 114-2, 116-2 from second or strip position (FIGS. 15-16) to the first or load/unload position (FIGS. 13-14).

Once tool 110 is in the first or load/unload position, the user inserts cable 30 into the tool through inlet guide 178 until the end of the cable contacts first beam 148, centers the cable with respect to nozzles 180-1, 180-2, and releases the pressure from primary handles 114-1, 116-1 so that biasing members 146 return blade subassemblies 114-2, 116-2 from first or load/unload position (FIGS. 13-14) to second or strip position (FIGS. 15-16).

Again and without wishing to be bound by any particular theory, it is believed that tool 110, due to the use of biasing members 146, instead of hand pressure, to close the tool onto cable 30 provide a uniform/repeatable pressure of blades 118, 124 on the cable. Simply stated, tool 110 via members 146 removes the variable pressure based on how hard the user squeezes during the stripping process, which has been found to provide a more repeatable stripping process then possible with hand pressure stripping tools.

Once tool 110 is in the second or strip position, the tool can be rotated about cable axis (C_{A}) to just over 180-degrees to complete the severing of layers 32, 34, 36 to be stripped from cable 30. Once severed, tool 110 can be moved along cable axis (C_{A}) to remove the severed layers from conductor 38.

After stripping cable 30, the portions of layers 32, 34, 36 stripped from the cable are captured within tool 110 by first beams 148 and inlet guides 178. Finally, the user can remove the portions of layers 32, 34, 36 remaining in tool 110 by again applying pressure to primary handles 114-1, 116-1 sufficient to overcome the biasing force of members 146 and move blade subassemblies 114-2, 116-2 from second or strip position (FIGS. 15-16) back to the first or load/unload position (FIGS. 13-14)—where during this movement ejection pins 188 protrude into nozzles 180-1, 180-2 to eject any portion of the stripped cable 30 from the tool. Once removed, the user can cease applying pressure to primary handles 114-1, 116-1 to allow biasing members 146 to return blade subassemblies 114-2, 116-2 to the second or strip position (FIGS. 15-16).

In this manner, tool 110 is configured to ensure that the layers of cable 30 can be stripped as shown in FIG. 6—namely with jacket layer 32 stripped by first length (L₁) and with jacket, shield, and dielectric layers 32, 34, 36 stripped by second length (L₂). Thus, tool 110 creates symmetrical and even cuts through specific layers of cable 30 and at specific locations in a precise and repeatable manner. In short, tool 110 provides two cuts of the layers of cable in a single stripping process.

Furthermore, tool 110 is configured to ensure blades 118, 124 remain in a desired position with respect to one another when in the housing sections 114, 116 are in the second or stripping position—namely with blades 124 having edges spaced from one by first dimension (D₁) and with blades 118 having edges spaced by second dimension (D₂).

Advantageously and in this manner, beams 148, 150, shoulder 174, and biasing members 146 cooperate to allow tool 110 to be easily and repeatably used to strip cables to the configuration shown in FIG. 6.

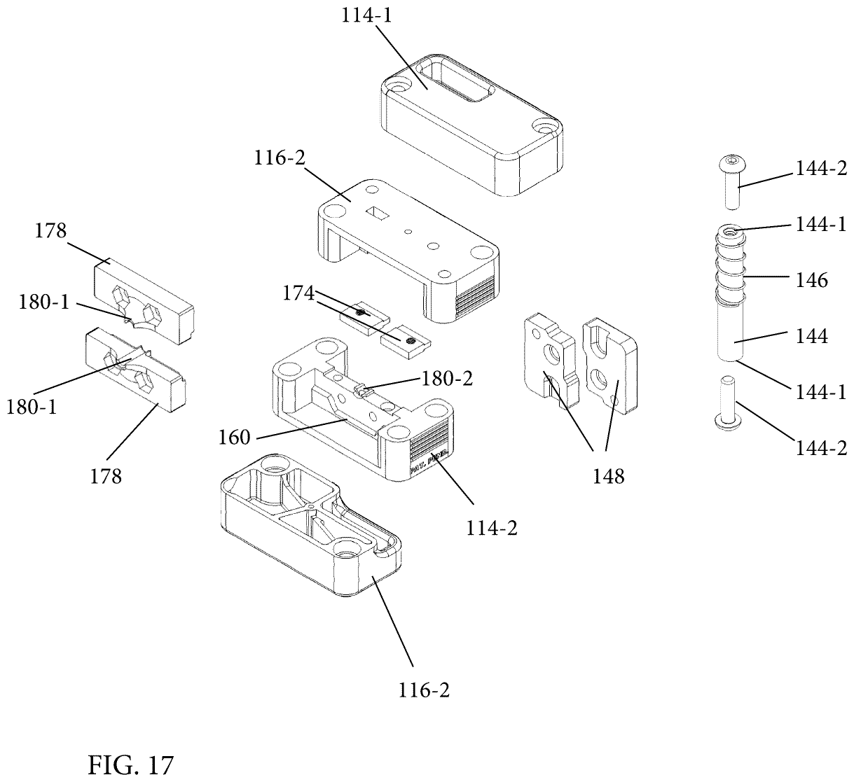

In some embodiments, tool 110 is configured for ease of manufacture and assembly by providing various components of first and second housing sections 114, 116 as symmetrical to one another. As shown in FIG. 17, primary handles 114-1 and 116-1 and blade subassemblies 114-2 and 116-2 are identical to one another but assembled in opposite directions. Similarly, first beams 148, shoulders 176, and inlet guides 178 are identical to one another but assembled in opposite directions. Of course, it is contemplated by the present disclosure for tool 110 have one or more components that are non-symmetrical with respect to one another.

The components of tool 110 can be made of any material having sufficient strength and rigidity to strip cables 30. In some embodiments, primary handles 114-1, 116-1, blade subassemblies 114-2, 116-2, guide shafts 144, first beams 148, shoulders 176, inlet guides 178 are formed of materials such as molded polymer(s), molded metals, cast metals, and others.

It should also be noted that the terms “first”, “second”, “third”, “upper”, “lower”, “inner”, “outer”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiments disclosed as the best mode contemplated, but that the disclosure will include all embodiments falling within the scope of the appended claims.

LIST OF REFERENCE NUMERALS

| | |
|---|---|
| cable stripping tool 10 | threaded fasteners 72 |
| first housing section 14 | shoulder 74 |
| second housing section 16 | tapered ramp 76 |
| first blade set 18 | cable stripping tool 110 |
| blades 20, 22 | first housing section 114 |
| second blade set 24 | second housing section 116 |
| blades 26, 28 | primary handle 114-1 |
| cable 30 | blade subassembly 114-2 |
| outer or jacket layer 32 | guide shafts 144 |
| shield layer 34 | primary handle 116-1 |
| dielectric layer 36 | blade subassembly 116-2 |
| center conductor 38 | threaded ends 144-1 |
| braided layer 40 | fasteners 144-2 |
| foil layer 42 | biasing member 146 |
| first length (L₁) | first beam 148 |
| cable axis (C_{A}) | first blade 118 |
| second length (L₂) | second blade 124 |
| guide shaft 44 | second beam 150 |
| biasing member 46 | upper surface 154 |
| first beam 48 | first shelf 160 |
| second beam 50 | second shelf 162 |
| third length (L₃) | shoulder 174 |
| end 52 | inlet guide 178 |
| top surface 54 | first nozzle 180-1 |
| first dimension (D₁) | second nozzle 180-2 |
| second dimension (D₂) | recesses 182 |
| first shelf 60, 62 | first fasteners 184 |
| second shelf 66, 68 | second fasteners 186 |
| | ejection pin 188 |

What is claimed is:

1. A tool for stripping a cable, comprising:
a first housing section having a first blade;
a second housing section having a second blade; and
a first beam secured to the first and second housing sections, the first and second housing sections being linearly movable with respect to one another between a load/unload position and a strip position,
wherein the first and second blades, when in the load/unload position, are spaced from one another by a distance that is larger than an outer diameter of the cable,
wherein the first and second blades, when in the strip position, are spaced from one another by a first dimension (D₁) that is substantially equal to an outer diameter of a conductor of the cable, and
wherein the first beam is positioned with respect to the first and second blades to define a travel limiter to the cable such that an end of the cable in contact with a surface of the first beam is a predefined first length (L1) from the first and second blades.

2. The tool of claim 1, wherein the first and second housing sections each have a shoulder, the first and second blades having a cutting edge in contact with the shoulder, respectively, to ensure that the cutting edges are spaced by the first dimension (D₁).

3. The tool of claim 2, wherein the first and second housing sections each have a first shelf on which the first and second blades are secured by one or more threaded fasteners, respectively.

4. The tool of claim 3, wherein the first and second housing sections each have a tapered ramp opposite the shoulder, respectively, and wherein the tapered ramp is inclined towards the shoulder such that, upon tightening of the threaded fastener, the first and second blades are biased against the shoulder, respectively.

5. The tool of claim 1, wherein the first housing section has a third blade and the second housing section has a fourth blade,
wherein the third and fourth blades, when in the load/unload position, are spaced from one another by a distance that is larger than the outer diameter of the cable,
wherein the third and fourth blades, when in the strip position, are spaced from one another by a second dimension (D₂) that is substantially equal to an outer diameter of a shield layer of the cable.

6. The tool of claim 5, wherein the first beam is positioned to define a second length (L2) from the third and fourth blades.

7. The tool of claim 5, wherein the first and second housing sections further comprise a second beam, the first and second blades being on one side of the second beam and the third and forth blades being on an opposite side of the second beam, the second beam defining a predefined third length (L3) therebetween.

8. The tool of claim 1, further comprising a guide shaft and a biasing member, the first and second housing sections being slidably engaged with the guide shaft for movement between the load/unload position and the strip position, the biasing member normally biasing the first and second housing sections to the load/unload position or to the strip position.

9. The tool of claim 1, wherein the first housing section and the second housing section each have a primary handle and a blade subassembly, the blade subassemblies carrying the first and second blades.

10. A tool for stripping a cable, comprising:
a first housing section and a second housing section each having a primary handle, a blade subassembly, a shoulder, a first beam, and a biasing member,
the primary handle of the first housing section being operatively connected to the blade subassembly of the first housing section,
the primary handle of the second housing section being operatively connected to the blade subassembly of the second housing section,
the blade subassemblies moving with respect to one another between a load/unload position and strip position,
the blade subassemblies each having a first blade and a second blade,
the first beam being positioned with respect to the first blades to define a travel limiter to the cable such that an end of the cable in contact with the first beam is a first length (L1) along a cable axis (C_{A}) from the first blades and is a second length (L₂) along the cable axis (C_{A}) from the second blades;
the blade subassemblies each having a second beam that separate the first and second blades from one another by a third length (L3) along the cable axis (C_{A}),
the shoulder defines a second datum that sets the cutting edge of the first blades distanced from one another by a first dimension (D₁) that is substantially equal to an outer diameter of a conductor of the cable and the cutting edge of the second blades distanced from one another by a second dimension (D₂) that is substantially equal to an outer diameter of a shield layer of the cable,
the first and second blades, when in the load/unload position, being spaced from one another by a distance that is larger than an outer diameter of the cable, and
the first and second blades, when in the strip position, are spaced from one another by a distance that is substantially equal to the first and second dimensions (D₁, D₂).

11. The tool of claim 10, wherein the biasing members normally bias the first and second housing sections to the strip position.

12. The tool of claim 10, wherein the shoulder is secured to an upper surface of the second beam.

13. The tool of claim 10, wherein the shoulder is integrally formed as one piece with the second beam.

14. The tool of claim 10, wherein the first and second housing sections each further comprise an inlet guide.

15. The tool of claim 14, wherein the inlet guide comprises a first nozzle to guide the cable and the blade subassembly has a second nozzle to guide the cable, the second nozzle being on the second beam.

16. The tool of claim 14, wherein the first beams and the inlet guides, when in the strip position, enclose portions stripped from the cable.

17. The tool of claim 15, wherein the first and second housing sections each further comprise an ejection pin, the ejection pins withdrawn into the blade subassemblies in the strip position and extending from the blade subassemblies in the load/unload position.

18. A method of stripping a cable, comprising:
inserting the cable into a stripping tool when first and second housing sections of the stripping tool are in a load/unload position until an end of the cable contacts an upper surface of a first beam;
moving the first and second housing sections of the stripping tool to a strip position;
rotating the stripping tool and the cable at least 180-degrees about a cable axis (C_{A}) with respect to one another while the housing sections are in the stripping position; and
moving the stripping tool and the cable with respect to one another along the cable axis (C_{A}) while the first and second housing sections are in the stripping position to strip portions from the cable.

19. The method of claim 18, further comprising applying pressure, prior to inserting the cable, to the first and second housing sections to overcome a biasing member to move the first and second housing sections from the stripping position to the load/unload position,
wherein the step of moving the first and second housing sections to the stripping position comprises releasing the pressure so that the biasing member returns the first and second housing sections to the stripping position.

20. The method of claim 19, further comprising applying pressure, after the portions have been stripped from the cable, to the first and second housing sections to overcome the biasing member to move the first and second housing sections from the stripping position to the load/unload position so as to eject the portions from the stripping tool.
